(19) United States
(12) Patent Application Publication
(10) Pub. No.: US 2009/0263999 A1
(43) Pub. Date: Oct. 22, 2009

(54) POWER PLUG, POWER OUTLET, POWER SUPPLY DEVICE AND POWER SUPPLY SYSTEM

(75) Inventor: Koji Onoue, Nishinomiya-shi (JP)

Correspondence Address: DITTHAVONG MORI & STEINER, P.C., 918 Prince St., Alexandria, VA, 22314, US

(73) Assignee: ISD CORPORATION, Nishinomiya-shi (JP)

(21) Appl. No.: 12/346,478

(22) Filed: Dec. 30, 2008

(30) Foreign Application Priority Data
Apr. 22, 2008 (JP) 2008-111622
Sep. 22, 2008 (JP) 2008-242964

(51) Int. Cl. H01R 4/58; H01R 3/00; H01R 24/00

(52) U.S. Cl. 439/215; 439/489; 439/660; 180/65.21

(57) ABSTRACT

A power plug, power outlet, power supply device and power supply system for preventing electricity theft with relatively simple configuration are provided. A power outlet unit supplies power to a power plug unit to establish communication over a power line between a PLC block of the power outlet unit and a PLC block of the power plug unit. Upon transmission of an ID number from the power plug unit, the transmitted ID number is compared with an ID number stored in a memory. If the ID number matches the ID number in the memory, power is continuously supplied to the power plug unit. If the ID number does not match, the power supply is shut down to prevent electricity theft.

### BACKGROUND OF THE INVENTION

1. Field of the Invention

This invention relates to a power plug, a power outlet, a power supply device and power supply system that are used to supply power, for example, in order to charge the battery of a plug-in hybrid electric vehicle from an outlet outside the building.

2. Description of Background Art

Electric vehicles can run on a gasoline engine and an electric motor driven by electric power supplied from a battery. In such recent electric vehicles, plug-in hybrid electric vehicles, each of which has a battery rechargeable by inserting the plug into a household outlet, are nearing practical use. To recharge the battery of the plug-in hybrid electric vehicle at home, it is necessary to install a power outlet outside the house; however, the outdoor power outlet is exposed to third parties who might steal electricity therefrom. Especially, a residential housing complex, such as an apartment, having its own parking area relatively separated from individual dwellings is more likely to suffer from electricity theft.

Japanese unexamined patent publication No. 2006-244818 describes a power supply system for preventing such electricity theft. This power supply system includes a power plug with an IC tag in which a user ID is stored. When the power plug is inserted into a power outlet, a tag reader reads the user ID from the IC tag and it is verified whether the user ID has been registered in a tag database. After verification of the registration, commercial power is supplied from the power outlet to the power plug.

The power supply system disclosed in publication No. 2006-244818 requires the tag reader for reading out the user ID from the IC tag in the power plug, which complicates the system configuration. In addition, the security of the system is not always guaranteed against electricity theft because the user ID can be read out from the IC tag with relative ease.

### BRIEF SUMMARY OF THE INVENTION

The present invention has an object to provide a power plug, a power outlet, a power supply device and a power supply system that are capable of preventing electricity theft with a relatively simple structure.

The present invention is directed to a power outlet for supplying electric power to a power plug. The power outlet includes outlet-side power-line communication unit that establishes communication over a power line with the power plug and outlet-side control unit that supplies power to the power plug to establish communication over the power line through the outlet-side power-line communication unit, and starts and stops supplying the power to the power plug based on identification data indicating that the power plug is permitted to be supplied with power and previously assigned identification data. The identification data indicating that the power plug is permitted to be supplied with power is transmitted from the power plug over the power line.

The use of power line communication eliminates the need for special communication unit between the power plug and power outlet. In addition, the present invention is so configured to supply power to the power plug only when the identification data transmitted from the power plug over the power line is recognized as identification data indicating that the power plug is permitted to be supplied with power. Therefore, even if a power plug to which the identification data is not assigned is inserted into the power outlet, power is not supplied to the power plug and thus prevented from being stolen.

More preferably, the power outlet includes detection unit that detects that the power plug has been inserted. The outlet-side control unit includes communication establishing unit that causes the outlet-side power-line communication unit to establish communication over the power line with the power plug when the detection unit detects that the power plug has been inserted.

More preferably, the outlet-side control unit includes a supply/shutdown control unit that supplies and shuts down power to the power plug and power-supply control unit. The power-supply control unit controls the supply/shutdown control unit to start supplying power to the power plug when the detection unit detects that the power plug has been inserted, and after the establishment of the communication over the power line by the communication establishing unit, controls the supply/shutdown control unit to stop supplying the power to the power plug when the detection unit detects that the power plug has been pulled out.

After the detection of the absence of the power plug, the power supply to the power outlet is stopped. Even if a third party inserts his/her power plug into the power outlet without permission, power will never be supplied, thereby preventing electricity theft.

Preferably, the power outlet includes outlet-side storage unit that stores identification data indicating that the power plug is permitted to be supplied with power. The outlet-side control unit determines whether identification data transmitted from the power plug matches identification data stored in the outlet-side storage unit.

Advance storage of the identification data, which indicates that the power plug is permitted to be supplied with power, in outlet-side storage unit makes it easier to determine whether the identification data transmitted from the power plug indicates that the power plug is permitted to be supplied with power.

In another aspect, the present invention is directed to a power plug that is supplied with electric power by inserting itself into a power outlet. The power plug includes: plug-side power-line communication unit that establishes communication over a power line with the power outlet; and plug-side control unit that receives power supplied from the power outlet upon inserting the power plug into the power outlet and causes the plug-side power-line communication unit to transmit identification data indicating that the power plug is permitted to be supplied with power to the power outlet over the power line.

By transmitting the identification data indicating that the power plug is permitted to be supplied with power to the power outlet, the power plug can receive the power.

In yet another aspect, the present invention is directed to a power supply device including a power outlet and a power plug. The power outlet for supplying electric power to the power plug includes: outlet-side power-line communication unit that establishes communication over a power line with the power plug; and outlet-side control unit that supplies power to the power plug to establish communication over the power line, and starts and stops supplying power to the power plug based on identification data indicating that the power plug is permitted to be supplied with power and previously assigned identification data. The identification data indicating that the power plug is permitted to be supplied with commercial power is transmitted from the power plug through the power line communication established by the outlet-side power-line communication unit. The power plug that is supplied with electric power by inserting itself into the power outlet includes: plug-side power-line communication unit that establishes communication over a power line with the power outlet; and plug-side control unit that receives power supplied from the power outlet upon inserting the power plug into the power outlet and causes the plug-side power-line communication unit to transmit identification data indicating that the power plug is permitted to be supplied with power to the power outlet over the power line.

The use of power line communication eliminates the need for special communication means between the power plug and power outlet. In addition, the power supply device is so configured as to supply power to the power plug only when the identification data transmitted over the power line is recognized as identification data indicating that the power plug is permitted to be supplied with power. Therefore, even if a power plug to which the identification data is not assigned is inserted into the power outlet, electric power is not supplied to the power plug and thus prevented from being stolen.

Preferably, the power outlet includes outlet-side storage unit that stores identification data indicating that the power plug is permitted to be supplied with power. The power plug includes plug-side storage unit that stores identification data indicating that the power plug is permitted to be supplied with power. The power supply device further includes setting unit that is used to assign the identification data, which indicates that the power plug is permitted to be supplied with power, to be stored in the outlet-side storage unit and the plug-side storage unit.

The setting unit makes it possible to assign any type of identification data indicating that power supply is permitted.

In yet another aspect, the present invention is directed to a power supply system including the power supply device described above and a computer. The power outlet includes an outlet-side network interface section used to connect the power outlet to a network and transmission unit that transmits identification data through the outlet-side network interface section to said computer. The identification data indicates that the power plug is permitted to be supplied with power. The computer includes: a computer-side network interface section used to connect said computer to said network; computer-side storage unit that stores specific information associated with the identification data indicating that said power plug is permitted to be supplied with power; determination unit that determines whether the identification data transmitted by the transmission unit matches the specific information stored in the computer-side storage unit, the identification data indicating that said power plug is permitted to be supplied with power; and execution unit that executes predetermined operations according to the result determined by the determination unit.

This configuration allows the power supply system to execute predetermined operations according to whether the identification data indicating that the power plug is permitted to be supplied with power corresponds to the specific information, e.g. stolen-car data. As a result, the power supply system helps to more easily find stolen cars.

The power outlet according to the present invention uses power line communication to eliminate the need for special communication means between the power plug and power outlet. In addition, the present invention is so configured to supply power to the power plug only when the identification data transmitted from the power plug over the power line is recognized as identification data indicating that the power plug is permitted to be supplied with power. Even if a power plug to which the identification data has not been assigned is inserted into the power outlet, power is not supplied to the power plug and therefore prevented from being stolen.

The power plug according to the present invention can receive power by transmitting the identification data, which indicates permission for the power plug to be supplied with power, to the power outlet.

The power supply device according to the present invention uses power line communication to eliminate the need for special communication means between the power plug and power outlet. In addition, the power supply device is so configured to supply power to the power plug only when the identification data transmitted from the power plug over the power line is recognized as identification data indicating that the power plug is permitted to be supplied with power. Even if a power plug to which the identification data has not been assigned is inserted into the power outlet, power is not supplied to the power plug and therefore prevented from being stolen.

The power supply system according to the present invention can execute predetermined operations according to whether the identification data, which indicates that the plug is permitted to be supplied with power, corresponds to specific information, for example, stolen-car data. As a result, the power supply system helps to more easily find stolen cars.

### BRIEF DESCRIPTION OF THE DRAWINGS

FIG. 1 is a block diagram showing a power supply device including a power outlet and a power plug and a setting unit according to an embodiment of the present invention.

FIG. 2 illustrates the power outlet unit and power plug unit, shown in FIG. 1, connected to each other.

FIGS. 3A to 3C are flow charts for explaining the operations of assigning an ID number to the power outlet unit and power plug unit.

FIG. 4 is a flow chart for explaining the operations of the power supply device according to the embodiment of the invention.

FIG. 5 is a block diagram of a power supply device according to another embodiment of the present invention.

FIG. 6 illustrates an exemplary power supply system according to yet another embodiment of the present invention.

FIGS. 7A and 7B are flow charts for explaining the operations of the power supply system according to the yet another embodiment of the present invention.

### DESCRIPTION OF PREFERRED EMBODIMENT

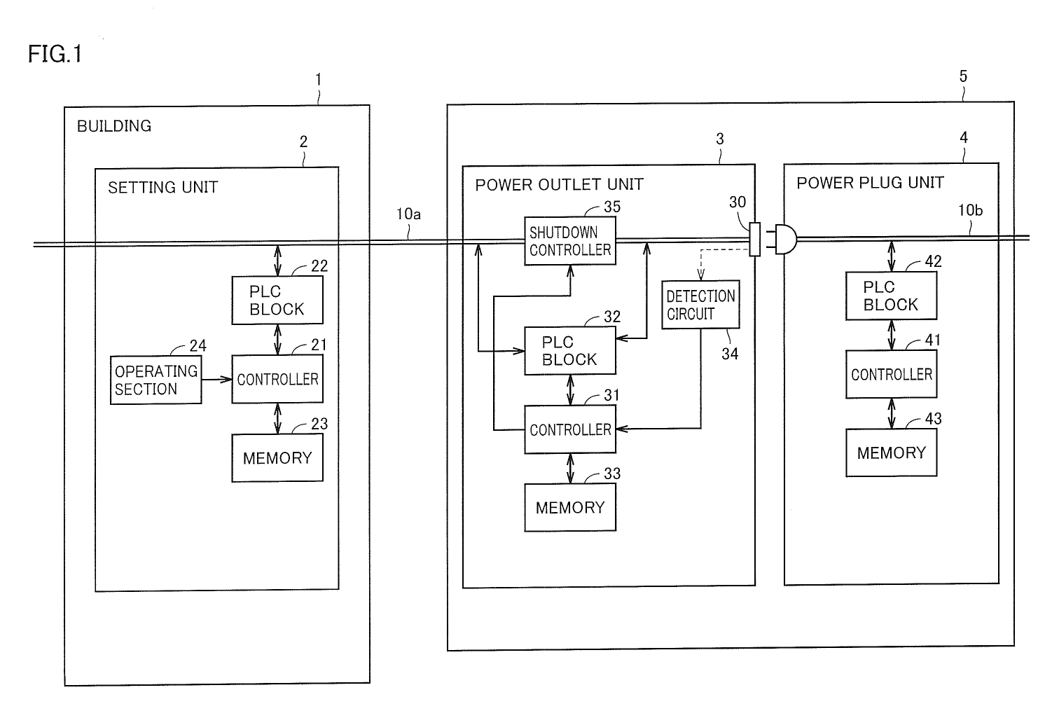

FIG. 1 is a block diagram of a power supply device 5 including a power outlet and a power plug and a setting unit 2 according to an embodiment of the present invention.

In FIG. 1, the power supply device 5 includes a power outlet unit 3, which is a power outlet, and a power plug unit 4, which is a power plug inserted into the power outlet unit 3. The setting unit 2 operating as setting unit is provided in a building 1. The setting unit 2 assigns an ID number, which is identification data for determining whether electric power is permitted to be supplied to the power plug unit 4, to the power outlet unit 3 and power plug unit 4. A power cable 10a is supplied with commercial power. The power cable 10a connects the setting unit 2 and power outlet unit 3.

The setting unit 2 includes a controller 21, a PLC (Power Line Communication) block 22 serving as power-line communication unit, a memory 23 and an operating section 24.

When an outlet number of the power outlet unit 3, a plug number of the power plug unit 4 and an ID number are input from the operating section 24, the controller 21 stores the outlet number, plug number and ID numbers in the memory 23. The outlet number, plug number and ID number stored in the memory 23 are used to determine whether the power plug unit 4 has permission to be supplied with electric power or for other purposes. The controller 21 controls the PLC block 22 to transmit the outlet number, plug number and ID number over the power cables 10a, 10b to the power outlet unit 3 and power plug unit 4.

The PLC block 22 superimposes a high-frequency signal, which functions as a carrier wave, on the power cable 10a as a power source and interactively communicates over the power cable 10a as a transmission path with the PLC block 32 of the power outlet unit 3. The power line communication system is categorized into a spread spectrum system, an OFDM (Orthogonal Frequency Division Multiplexing) system and some other systems. The spread spectrum system is used in this embodiment.

The spread spectrum system is a technique by which a signal with a narrow bandwidth at the sending end is transmitted and spread over a wide bandwidth according to a spreading code. The receiving end follows the process performed by the sending end in reverse to return the wide bandwidth signal to the original narrow bandwidth signal with the same spreading code. In the spread spectrum system, the narrow-band noise that undergoes the reverse spreading at the sending end is turned into a wide-band low-level noise that is robust against noise in any parts of the narrow bandwidth. In addition, the spreading of the signal at the sending end can maintain the peak value of the signal at low, thereby reducing the peak leakage field.

The power outlet unit 3 includes a terminal strip 30, a controller 31 serving as outlet-side control unit, communication establishing unit and power-supply control unit, a PLC block 32 serving as outlet-side power-line communication unit, a memory 33, which is an embedded memory and serves as outlet-side storage unit, a detection circuit 34 serving as detection unit, and a shutdown controller 35 serving as supply/shutdown control unit. It is supposed there is more than one power outlet unit 3. For example, a plurality of power outlet units 3 may be installed on an outer wall or other parts of the building 1.

The terminal strip 30 accepts the insertion terminals of the power plug unit 4. The controller 31 controls the PLC block 32 and shutdown controller 35 and also operations of reading and writing data from and in the memory 33. The PLC block 32 communicates over the power cable 10a with the PLC block 22 of the setting unit 2 and communicates over the power cable 10b with a PLC block 42 of the power plug unit 4. The memory 33 stores ID numbers. The ID number is used in the power outlet unit 3 to judge whether the inserted power plug unit 4 is permitted to be supplied with electric power. In the case where the plurality of power plug units 4 are permitted to be supplied with power, the memory 33 of the power outlet unit 3 stores the same number of ID numbers as those stored in the plurality of power plug units 4. The memory 33 also stores plug numbers. Each plug number, which could be a production number, serial number or other numbers assigned in advance before shipment, is used to identify each of the power outlet units 3. The detection circuit 34 detects whether the insertion terminals of the power plug unit 4 have been inserted into the terminal strip 30. The detection by the detection circuit 34 whether the power plug unit 4 is present in the terminal strip 30 is made using, for example, a pulse signal. Specifically, the detection circuit 34 sends a pulse signal to the power plug unit 4 and determines that the power plug unit 4 has been inserted in the terminal strip 30 if the detection circuit 34 receives a response to the sent pulse signal. The shutdown controller 35 starts and stops the supply of electric power to the terminal strip 30 according to the control of the controller 31.

The power outlet unit 3 can be switched among a registration mode, normal mode and constant energization mode. The registration mode denotes a state where the power outlet unit 3 is capable of storing ID numbers in the memory 33. The normal mode denotes a state where the power outlet unit 3 is capable of energizing only the power plug units 4 matching the ID numbers stored in the memory 33. The constant energization mode denotes a state where the power outlet unit 3 is capable of energizing any of the power plug units 4 irrespective of whether the power outlet 3 can match a ID number in the memory 33.

The power plug unit 4 includes a controller 41 serving as plug-side control unit, a PLC block 42 serving as plug-side power-line communication unit, and a memory 43 which is an embedded memory and serves as plug-side storage unit. It is supposed there is more than one power plug unit 4.

The controller 41 controls the PLC block 42 and also operations of reading and writing data from and in the memory 43. The PLC block 42 communicates over the power cable 10b with the PLC block 32 of the power outlet unit 3. The memory 43 stores an ID number. This ID number allows the power outlet unit 3 to determine whether the power plug unit 4, which was just inserted into the power outlet unit 3, is permitted to be supplied with power. For example, each of power plug units 4 stores a different ID number unique to itself. The memory 43 also stores a plug number. The plug number, which could be a production number, serial number or other numbers assigned in advance before shipment, is used to identify a power plug unit 4. The plurality of power plug units 4 have plug numbers different from each other.

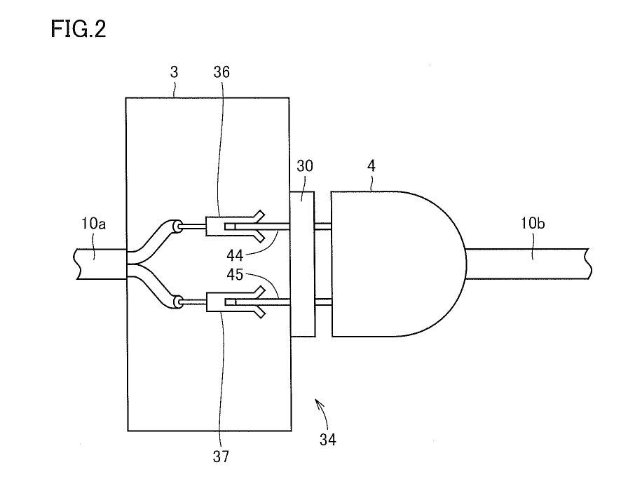

FIG. 2 illustrates the power outlet unit 3 and power plug unit 4, shown in FIG. 1, connected to each other. In FIG. 2, the wires of the power cable 10a are connected to receiving terminals 36, 37, respectively. Insertion terminals 44, 45 of the power plug unit 4 are inserted through the terminal strip 30 and received by the receiving terminals 36, 37. When the power plug unit 4 is inserted into the terminal strip 30 of the power outlet unit 3, power is supplied from the power cable 10a through the receiving terminals 36, 37 and the insertion terminals 44, 45 of the power plug unit 4 to the power cable 10b.

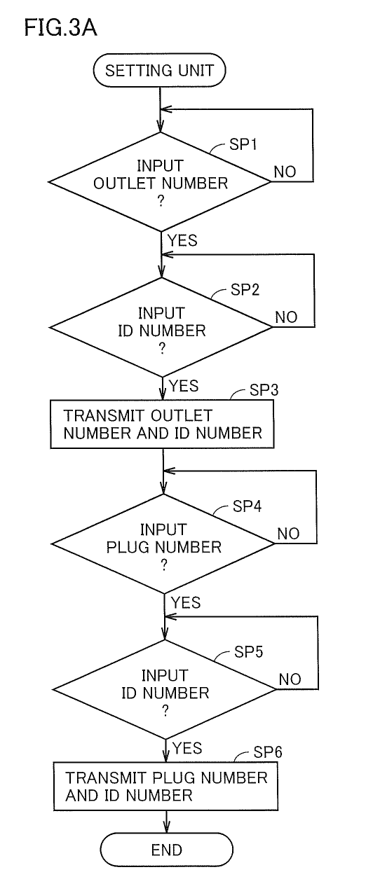

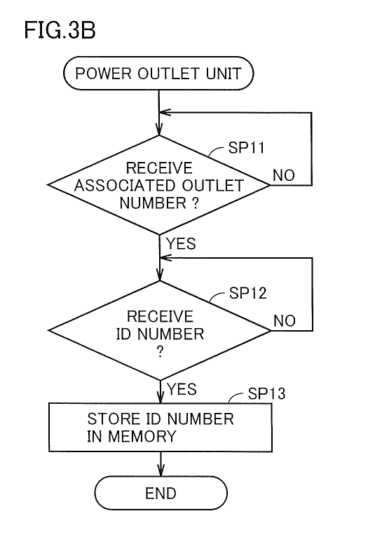

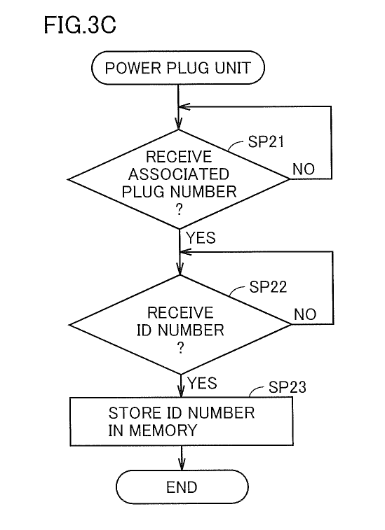

Next description will be made about how the setting unit 2 assigns ID numbers to the power outlet unit 3 and power plug unit 4. FIGS. 3A to 3C are flow charts of the operations of assigning an ID number to the power outlet unit 3 and power plug unit 4: FIG. 3A shows the operations of the setting unit 2; FIG. 3B shows the operations of the power outlet unit 3; and FIG. 3C shows the operations of the power plug unit 4.

In order to set the ID number, a power-line communication is established between the PLC block 22 of the setting unit 2 and the PLC block 32 of the power outlet unit 3. When the power plug unit 4 is inserted into the terminal strip 30 of the power outlet unit 3, the detection circuit 34 detects that the power plug unit 4 has been inserted and outputs a detection signal indicating the insertion of the power plug unit 4 to the controller 31. The controller 31 that detected the insertion of the power plug unit 4 turns on the shutdown controller 35 to pass electric power from the power cable 10a to the terminal strip 30. This supplies power to the power plug unit 4 and establishes the power-line communication between the PLC block 32 of the power outlet unit 3 and the PLC block 42 of the power plug unit 4. Then, the controller 31 goes to the registration mode.

First, a user inputs an outlet number and an ID number through the operating section 24 of the setting unit 2 with reference to a previously prepared list or the like of the outlet numbers for setting the ID numbers. In a case where there are a plurality of power outlet units 3, outlet numbers are input to identify the power outlet units 3, respectively. The ID number is input to identify a power plug unit 4 permitted to be supplied with power.

The controller 21 of the setting unit 2, in step (which is abbreviated as SP in the drawings) SP1 in FIG. 3A, determines whether the outlet number has been entered. When it is determined that the outlet number has been entered, the controller 21 determines whether the ID number has been entered in step SP2. When it is determined that the ID number has been entered, the controller 21 writes the outlet number and ID number in the memory 23 and causes the PLC block 22 to send out the outlet number and ID number over the power cable 10a in step SP3. The PLC block 22 establishes communication over the power cable 10a with the PLC block 32 of the power outlet unit 3 to send out the outlet number and ID number.

Note that establishment of a power-line communication is compete when the data that is transmitted over a power line from the PLC block 22 of the setting unit 2, which is a transmitter, is reconstructed in the PLC block 32 of the power outlet unit 3, which is a receiver.

The PLC block 32 of the power outlet unit 3 receives the outlet number and ID number sent out from the PLC block 22 of the setting unit 2 and outputs them to the controller 31. In step SP11 of FIG. 3B, the controller 31 determines whether it has received the outlet number associated therewith among the plurality of outlet numbers of the power outlet units 3. When it is determined that the outlet number has been received, the controller 31 determines whether it has received the ID number in step SP12. When the controller 31 determines that it has received the ID number, the received ID number is written in the memory 33 in step SP13.

Subsequently, the user inputs a plug number and ID number through the operating section 24 of the setting unit 2. The ID number is the same as that assigned to the power outlet unit 3.

The controller 21 of the setting unit 2 determines whether the plug number has been input in SP4. If it is determined that the plug number has been entered, the controller 21 then determines whether the ID number has been input in step SP5. If the ID number is determined to be entered, the controller 21 writes the plug number and ID number in the memory 23 and causes the PLC block 22 to send out the plug number and ID number over the power cable 10a in step SP6. The PLC block 22 sends out the plug number and ID number through the power cable 10a.

The PLC block 42 of the power plug unit 4 establishes communication over the power line with the PLC block 22 of the setting unit 2 to receive the plug number and ID number, and outputs them to the controller 41. In step SP21 shown in FIG. 3C, the controller 41 determines whether it has received the plug number associated therewith among the plurality of plug numbers of the power plug units 4. When it is determined that the plug number has been received, the controller 41 determines whether it has received the ID number in step SP22. When the controller 41 determines that it has received the ID number, the ID number is written in the memory 43 in step SP23.

In the above-described manner, the ID number, which is identification data to permit the use of electric power, can be assigned to the power outlet unit 3 and power plug unit 4 through the setting unit 2 after the power plug unit 4 is inserted into the power outlet unit 3. In addition, the memories 33, 43 in which the ID numbers are stored are embedded memories, thereby improving security. Upon completion of the ID number assignment, the user pulls the power plug unit 4 out of the power outlet unit 3.

Although the ID number, which is supposed to be set in the power plug unit 4, is assigned to the power plug unit 4 from the setting unit 2, it is possible to assign the ID number to the power plug unit 4 from the setting unit 2 through the controller 31 of the power outlet unit 3. Specifically, the outlet number, plug number, and the ID number are input from the setting unit 2 and sent out to the power outlet unit 3 once, and then communication is established over the power line between the PLC block 32 of the power outlet unit 3 and the PLC block 42 of the power plug unit 4 to transmit the plug number and ID number from the power outlet unit 3 to the power plug unit 4.

Although the power plug unit 4 was inserted into the terminal strip 30 of the power outlet unit 3 before the outlet number and ID number are assigned in the above description, the present invention is not limited thereto and the power plug unit 4 can be inserted into the terminal strip 30 of the power outlet unit 3 after assignment of the outlet number and ID number.

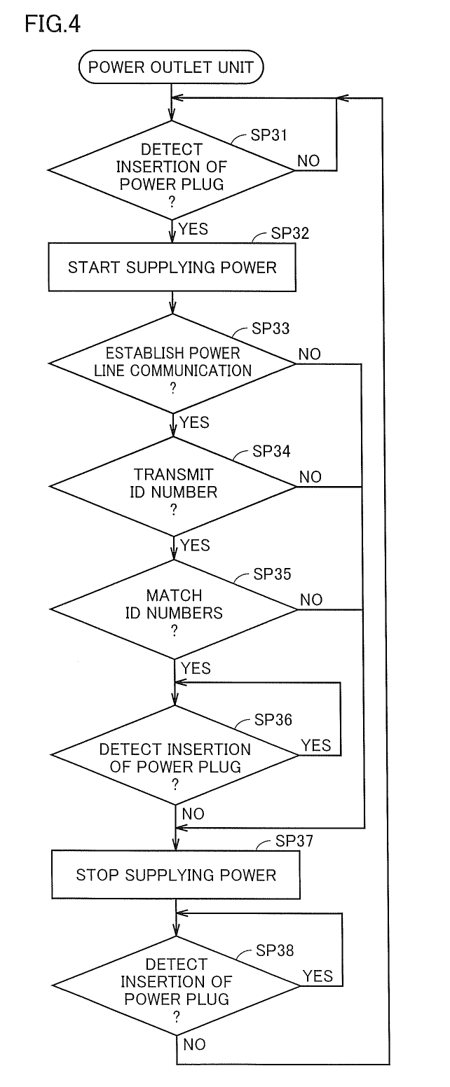

FIG. 4 is a flow chart for explaining the operations of the power supply device 5 according to the embodiment of the present invention. At the time of actual use, for example, when charging the battery of a user's own plug-in hybrid electric vehicle, the user first inserts the power plug unit 4 into the terminal strip 30 of the power outlet unit 3 as shown in FIG. 2. With the insertion of the power plug unit 4 into the terminal strip 30, the detection circuit 34 detects that the power plug unit 4 has been inserted and outputs a detection signal indicating the insertion of the power plug unit 4 to the controller 31.

When the controller 31 detects that the power plug unit 4 has been inserted in step SP31 of FIG. 4, the controller 31 turns on the shutdown controller 35 to feed electric power from the power cable 10a to the terminal strip 30 in step SP32. This supplies the power to the power plug unit 4, thereby establishing communication over the power line between the PLC block 32 of the power outlet unit 3 and the PLC block 42 of the power plug unit 4. The controller 31 goes to the aforementioned normal mode or constant energization mode. In this embodiment, the controller goes to the normal mode.

After the establishment of the power-line communication, the controller 41 of the power plug unit 4 reads out the ID number written in the memory 43 and causes the PLC block 42 to transmit the ID number over the power cable 10b.

The controller 31 of the power outlet unit 3 detects whether the power-line communication has been established in step SP33. If the communication over the power line is established, the controller 31 detects whether the ID number has been transmitted in step SP34. In step SP35, the controller 31 that detected the transmission of the ID number verifies whether the ID number in the memory 33 matches the ID number transmitted from the power plug unit 4. When the controller 31 recognizes the agreement between these ID numbers, the controller 31 allows the shutdown controller 35 to continuously supply power to the power plug unit 4 until the absence of the power plug 4 is detected in step SP36.

In the cases where the establishment of the power-line communication is not determined in step SP33, where the transmission of the ID number is not detected in step SP34, and where the agreement is not recognized in step SP35, the process goes to step SP37 where the shutdown controller 35 is turned off to stop energization.

After the battery of the plug-in hybrid electric vehicle is fully charged, the user pulls the power plug unit 4 out of the terminal strip 30. Since pulling out the power plug unit 4 involves withdrawal of the insertion terminals 44, 45, the controller 31 determines that the power plug unit 4 has been pulled out by means of the detection circuit 34 in step SP36, and turns off the shutdown controller 35 to stop energizing the power plug unit 4 in step SP37.

In step SP38, determination of whether or not the power plug unit 4 is in the power outlet unit 3 is made. If it is determined that the power plug unit 4 has been pulled out and is no longer present in the power outlet unit 3, the operation goes back to the initial state. If the power plug unit 4 is still in the power outlet unit 3, the state, that is a state where energization is stopped, is maintained. This operation is performed to prevent further energization to the power plug unit 4 that is once stopped to be supplied with power and is pulled out of the power outlet unit 3, unless the power plug unit 4 is inserted into the power outlet unit 3 again.

According to the above-described embodiment of the present invention, even if a power plug having no permission to receive power is inserted into the power outlet unit 3, power is forbidden to be supplied since there is no ID number to compare with and therefore power cannot be stolen. In addition, the use of the power line communication system to transmit the ID number eliminates the need for other communication media, thereby making the structure of the power supply device simple.

The power outlet unit 3 can be so configured as to accept a plurality of different power plug units 4. In this case, different ID numbers may be assigned to the power plug units 4 by the setting unit 2 and stored in the memory 33 of the power outlet unit 3. When any one of the power plug units 4 is inserted into the power outlet unit 3, this configuration makes it possible to identify the ID number of the power plug unit 4 and supply power to it. The ID numbers do not need to be different for each power plug unit 4, but a common ID number can be assigned to every power plug unit 4.

The aforementioned embodiment in which the detection circuit 34 uses a pulse signal to sense insertion of the power plug unit 4 into the terminal strip 30 is just an example and the present invention is not limited thereto. The insertion of the power plug unit 4 into the terminal strip 30 can be detected by an optical sensor or can be mechanically detected by a micro switch or the like.

Although the outlet number, plug number and ID number are stored in the memory 23 of the setting unit 2 in the above-described embodiment, these numbers do not need to be stored if there is no requirement to verify whether the power plug unit 4 has permission to be supplied with power.

Although the setting unit 2 is separately provided from the power supply device 5 in the aforementioned embodiment, the present invention is not limited thereto and the power supply device 5 can include a setting unit 2 therein.

Although a spread spectrum system is adopted into the power-line communication in the aforementioned embodiment, an OFDM system is also available. The OFDM system is a transmission scheme in which a large number of carriers are orthogonally multiplexed in frequency and has advantages such as high utilization efficiency of frequency and high speed processing. The OFDM system can control every carrier to transmit data. Even in a frequency band that may especially affect existing radio stations, the present invention employing the OFDM system is able to coexist with the existing radio stations by stopping (i.e., notching) the transmission of the required carrier.

The aforementioned embodiment in which the power outlet unit 3 is switchable among the registration mode, normal mode and constant energization mode, and for example, the power outlet unit 3 goes to the registration mode in order to assign the ID number, is just an example and the present invention is not limited thereto. The assignment of the ID number and other operations can be performed without the power outlet unit 3 entering any modes.

Although the aforementioned embodiment adopts a plurality of power outlet units 3 and power plug units 4 as an example, the present invention is not limited thereto and can be applied to the power supply system including a power outlet unit 3 and a power plug unit 4. In a case of providing a single power outlet unit 3, only the ID number but no outlet number is input. In a case of providing a single power plug unit 4, only the ID number but no plug number is input.

The aforementioned embodiment in which the outlet number is input through the operating section 24 of the setting unit 2 by referring to a previously-prepared list or the like of outlet numbers used to assign the ID number is just an example and the present invention is not limited thereto. For example, the power outlet unit 3 can be so configured as to notify the setting unit 2 of its own outlet number upon the establishment of power-line communication between the PLC block 22 of the setting unit 2 and the PLC block 32 of the power outlet unit 3, and consequently the user can input the outlet number by referring to the notified outlet number.

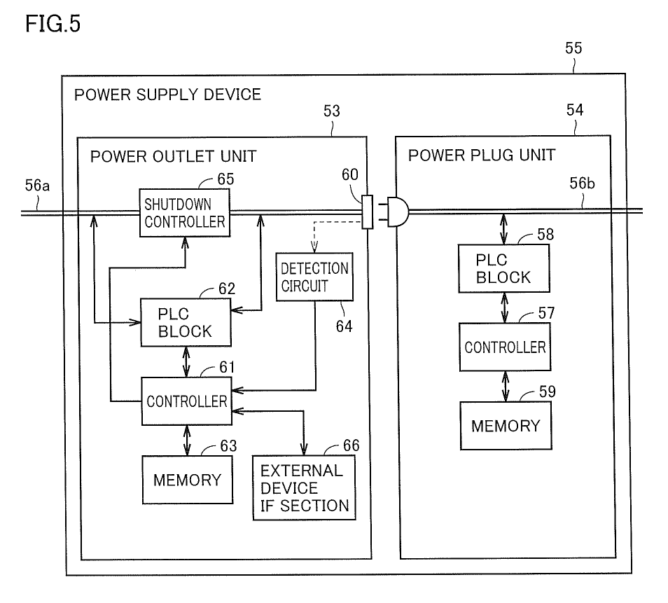

The aforementioned embodiment in which the setting unit 2 is provided to assign the ID number over the power-line communication between the PLC block 22 of the setting unit 2 and the PLC block 32 of the power outlet unit 3 is just an example and the present invention is not limited thereto. In another embodiment, an external device IF (interface) section, instead of the setting unit, can be provided in the power outlet unit in order to assign the ID number therethrough. FIG. 5 is a block diagram of the power supply device 55 according to the embodiment of the present invention.

Referring to FIG. 5, the power supply device 55 includes a power outlet unit 53 and a power plug unit 54. In this embodiment, there are one power outlet unit 53 and one power plug unit 54. The power outlet unit 53 further includes an external device IF section 66. The external device IF section 66 is used to connect an external device, such as a keyboard and a display, and the power outlet unit 53. In other words, such a keyboard or display is attached to the power outlet unit 53 through the external device IF section 66. The other components of the power supply device are the same as those in the aforementioned embodiment and therefore their descriptions will not be reiterated.

A process for assigning an ID number to the power outlet unit 53 and power plug unit 54 through the external device IF section 66 will be described below. First, a user inserts the power plug unit 54 into a terminal strip 60 of the power outlet unit 53. Upon the insertion of the power plug unit 54 into the terminal strip 60, a detection circuit 64 detects the inserted power plug unit 54 and outputs a detection signal indicating that the power plug unit 54 has been inserted to a controller 61.

When detecting that the power plug unit 54 has been inserted, the controller 61 turns on a shutdown controller 65 to pass electric power from a power cable 56a to the terminal strip 60. This supplies the power to the power plug unit 54 and thus establishes power-line communication between a PLC block 62 of the power outlet unit 53 and a PLC block 58 of the power plug unit 54. Then, the controller 61 goes to the registration mode.

The user makes a selection to set an ID number of the power outlet unit 53 and inputs the ID number using a keyboard. Then, the controller 61 writes the input ID number in a memory 63 of the power outlet unit 53.

Next, the user makes a selection to set the ID number of the power plug unit 54 and inputs the ID number using the keyboard. In response to that, the controller 61 causes the PLC block 62 to output the input ID number to the power cable 56a. The PLC block 62 transmits the ID number through the power cable 56a. The PLC block 58 of the power plug unit 54 establishes power-line communication with the PLC block 62 of the power outlet unit 53 to receive the ID number and outputs it to a controller 57. The controller 57 writes the ID number in a memory 59 of the power plug unit 54.

This configuration does not require a setting unit and realizes a simplified power supply device capable of assigning ID numbers.

The aforementioned embodiments in which the ID number is assigned by a user using the setting unit or external device are just examples and the present invention is not limited thereto. The ID number may be a production number or serial number given in advance before shipment.

Although the outlet number and plug number are a production number or serial number given in advance before shipment in this embodiment, the present invention is not limited thereto and, the outlet number and plug number can be assigned through the setting unit or external device in the same assignment manner of the ID number.

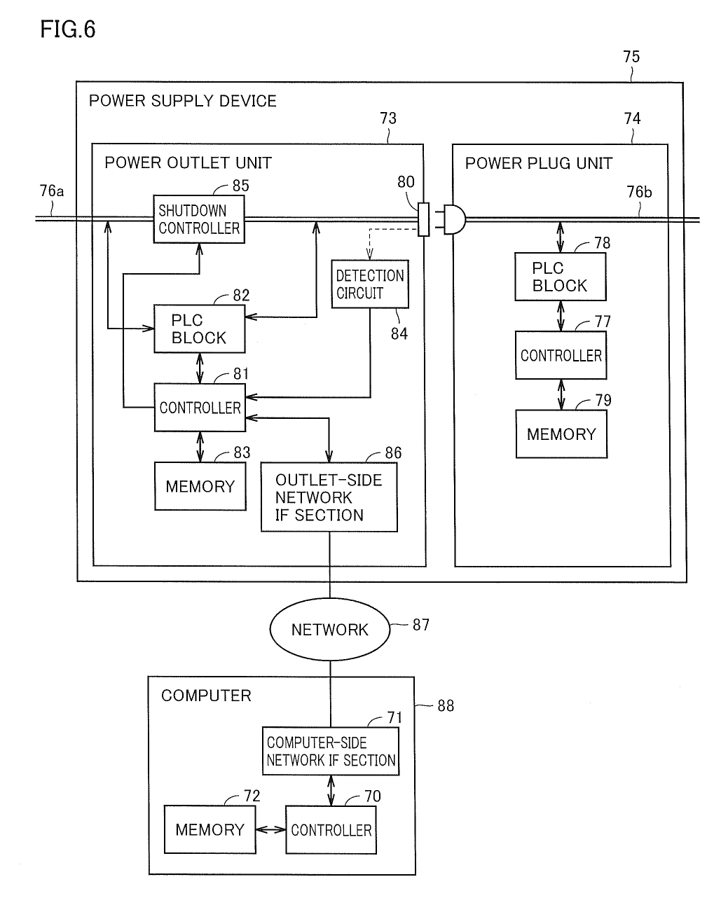

Next, a power supply system according to yet another embodiment of the present invention will be described below. FIG. 6 illustrates an example of power supply systems according to the yet another embodiment of the present invention.

Referring to FIG. 6, the power supply system comprises a power supply device 75 including a power outlet unit 73 and a power plug unit 74 and a computer (personal computer) 88.

The power outlet unit 73 includes an outlet-side network IF section 86 used to connect the power outlet unit 73 to a network 87 and a controller 81 operating as transmission unit. The computer 88, which is connected to the network 87, includes a computer-side network IF section 71 used to connect the computer 88 to the network 87, a controller 70 that controls the entire computer 88 and operates as determination unit and execution unit, and a memory 72 operating as computer storage unit. The memory 72 stores specific information associated with ID numbers. The other components are the same as those in the above-described embodiments and their description will not be reiterated.

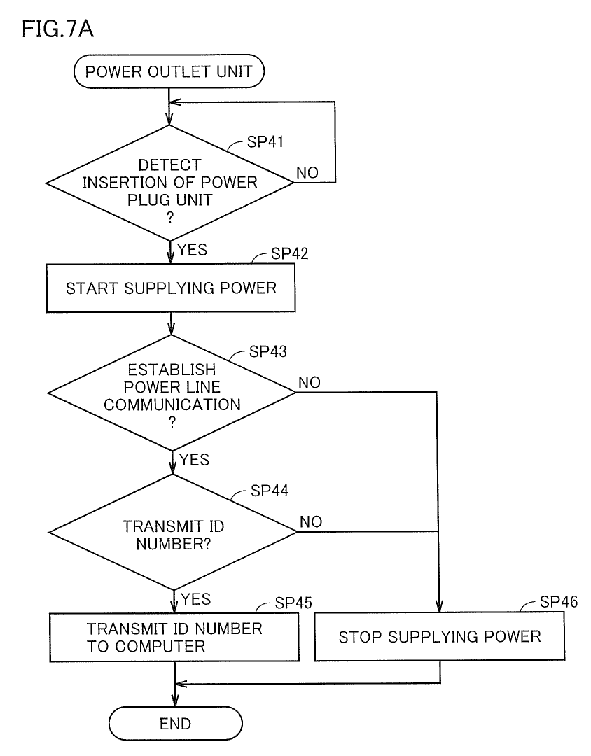

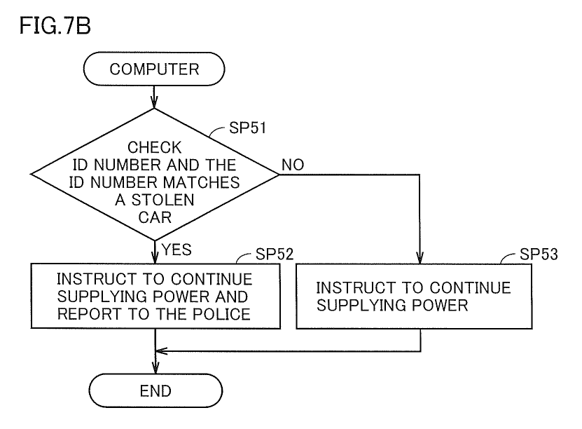

FIGS. 7A and 7B are flow charts for explaining the operations of the power supply system according to the embodiment of the present invention: FIG. 7A shows the operations of the power outlet unit 73; and FIG. 7B shows the operations of the computer 88.

When detecting that the power plug unit 74 has been inserted into the power outlet unit 73 in step SP41 of FIG. 7A, the controller 81 turns on a shutdown controller 85 to pass electric power from a power cable 76a to a terminal strip 80 in step SP42. As a result, the power plug unit 74 is supplied with power to establish power-line communication between a PLC block 82 of the power outlet unit 73 and a PLC block 78 of the power plug unit 74. Then, the controller 81 goes to the constant energization mode.

Once the power-line communication is established, the controller 77 of the power plug unit 74 reads out the ID number written in the memory 79 and causes the PLC block 78 to transmit the ID number over a power cable 76b.

The controller 81 of the power outlet unit 73 detects whether the power-line communication has been established in step SP43. If so, in step SP44, the controller 81 detects whether the ID number has been transmitted. When the controller 81 detects that the ID number has been transmitted, the controller 81 transmits the ID number through the outlet-side network IF section 86 to the computer 88 in step SP45.

In step SP51, the computer 88 checks the ID number against the specific information associated with the ID number stored in the memory 72, for example, checking the ID number against stolen car information, to determine whether the transmitted ID number corresponds to any stolen cars. More specifically, the transmitted ID number is associated with the manufacturer's serial number of the car, thereby determining if the serial number corresponds to any stolen cars.

According to the determination, predetermined operations are executed. If the ID number matches a stolen car, the computer directs the power outlet unit 73 through the computer-side network IF section 71 to continuously pass the power and simultaneously reports to the police in step SP52. If the ID number does not match any stolen cars, the computer instructs the power outlet unit 73 through the computer-side network IF section 71 to continuously pass the power in step SP53. The computer 88 is namely a stolen-car management center.

In the case where the controller 81 does not detect that the power-line communication has been established in step SP43 or where the controller 81 does not detect that the ID number has been transmitted in step SP44, the controller 81 advances to step SP46 to turn off the shutdown controller 85 to suspend energization.

According to whether the identification data, which indicates that the plug is permitted to be supplied with power, corresponds to the stolen-car data, the computer executes predetermined operations, e.g., reporting to the police. As a result, this system helps to more easily find stolen cars.

Although the computer that found an ID number corresponding to a stolen car is configured to instruct the power outlet unit 73 to continuously pass electric power and report to the police as predetermined operations in the aforementioned embodiment, the present invention is not limited thereto. The computer can be so configured as to instruct the power outlet unit 73 to stop supplying the power.

Although the aforementioned embodiment is an example of the power supply systems including no setting unit, the present invention is not limited thereto and can of course include the setting unit. The setting unit included in the power supply system can be so configured as to include a network IF section for network connection and transmit the ID number through the network IF section to the computer.

The foregoing has described the embodiment of the present invention by referring to the drawings; however, the invention should not be limited to the illustrated embodiment. It should be appreciated that various modifications and changes can be made to the illustrated embodiment within the scope of the appended claims and their equivalents.

What is claimed is:

1. A power outlet for supplying electric power to a power plug, comprising:
outlet-side power-line communication unit that establishes communication over a power line between said power outlet and said power plug; and
outlet-side control unit that supplies power to said power plug to establish communication over the power line through said outlet-side power-line communication unit, and starts and stops supplying power to said power plug based on identification data indicating that said power plug is permitted to be supplied with power and previously assigned identification data, said identification data indicating that said power plug is permitted to be supplied with power being transmitted from said power plug over the power line.

2. The power outlet according to claim 1, further comprising:
detection unit that detects that said power plug has been inserted; wherein
said outlet-side control unit includes communication establishing unit that causes said outlet-side power-line communication unit to establish said communication over the power line with said power plug when said detection unit detects that the power plug has been inserted.

3. The power outlet according to claim 2, wherein
said outlet-side control unit includes:
supply/shutdown control unit that supplies and shuts down power to said power plug; and
power-supply control unit that controls said supply/shutdown control unit to start supplying power to said power plug when said detection unit detects that the power plug has been inserted, and after the establishment of said communication over the power line by said communication establishing unit, controls said supply/shutdown control unit to stop supplying power to said power plug when said detection unit detects that the power plug has been pulled out.

4. The power outlet according to claim 1, further comprising:
outlet-side storage unit that stores identification data indicating that said power plug is permitted to be supplied with power, wherein
said outlet-side control unit determines whether identification data transmitted from said power plug matches identification data stored in said outlet-side storage unit.

5. A power plug that is supplied with electric power by inserting itself into a power outlet, comprising:
plug-side power-line communication unit that establishes communication over a power line with said power outlet; and
plug-side control unit that receives power supplied from said power outlet upon inserting said power plug into said power outlet and causes said plug-side power-line communication unit to transmit identification data indicating that said power plug is permitted to be supplied with power to said power outlet over the power line.

6. A power supply device including a power outlet and a power plug, wherein
said power outlet supplies electric power to said power plug and comprises:
outlet-side power-line communication unit that establishes communication over a power line with said power plug; and
outlet-side control unit that supplies power to said power plug to establish communication over the power line through said outlet-side power-line communication unit, and starts and stops supplying power to said power plug based on identification data indicating that said power plug is permitted to be supplied with power and previously assigned identification data, said identification data indicating that said power plug is permitted to be supplied with power being transmitted from said power plug over the power line, and
said power plug is supplied with power by inserting itself into said power outlet and comprises:
plug-side power-line communication unit that establishes communication over the power line with said power outlet; and
plug-side control unit that receives power supplied from said power outlet upon inserting said power plug into said power outlet and causes said plug-side power-line communication unit to transmit identification data indicating that said power plug is permitted to be supplied with power to said power outlet over the power line.

7. The power supply device according to claim 6, wherein
said power outlet comprises outlet-side storage unit that stores identification data indicating that said power plug is permitted to be supplied with power,
said power plug comprises plug-side storage unit that stores identification data indicating that said power plug is permitted to be supplied with power, and
said power supply device further comprises setting unit for assigning the identification data to be stored in said outlet-side storage unit and said plug-side storage unit, the identification data indicating that said power plug is permitted to be supplied with power.

8. A power supply system comprising the power supply device cited in claim 6 and a computer, wherein
said power outlet comprises:
an outlet-side network interface section used to connect said power outlet to a network; and
transmission unit that transmits identification data through said outlet-side network interface section to said computer, said identification data indicating that said power plug is permitted to be supplied with power, and
said computer comprises:
a computer-side network interface section used to connect said computer to said network;
computer-side storage unit that stores specific information associated with said identification data indicating that said power plug is permitted to be supplied with power;
determination unit that determines whether said identification data transmitted by said transmission unit matches said specific information stored in said computer-side storage unit, said identification data indicating that said power plug is permitted to be supplied with power; and
execution unit that executes predetermined operations according to the result determined by said determination unit.
